(19) United States
(12) Patent Application Publication
(10) Pub. No.: US 2012/0158540 A1
(43) Pub. Date: Jun. 21, 2012

(54) FLAGGING SUSPECT TRANSACTIONS BASED ON SELECTIVE APPLICATION AND ANALYSIS OF RULES

(75) Inventors: Visweswararao GANTI, Plano, TX (US); John Hans Van Arkel, Colorado Springs, CO (US)

(73) Assignee: VERIZON PATENT AND LICENSING, INC., Basking Ridge, NJ (US)

(21) Appl. No.: 12/970,080

(22) Filed: Dec. 16, 2010

(51) Int. Cl. G06Q 30/00

(52) U.S. Cl. 705/26.35

(57) ABSTRACT

A fraud management system is configured to store rules for detecting fraud. The fraud management system is configured to: receive a transaction involving a consumer and a merchant; select a set of the rules based on information associated with the transaction, information associated with the consumer, or information associated with the merchant; process the transaction, in parallel, using the selected rules to generate a set of alarms; group the alarms, into groups, based on information associated with the transaction; analyze the groups to generate a fraud score; and output information regarding the fraud score to the merchant to notify the merchant whether the transaction is potentially fraudulent.

### BACKGROUND

Merchants are much more responsible for the cost of fraud than are financial institutions and consumers. Accordingly, merchants are the most motivated victim group to adopt mitigation strategies. The mitigation strategies vary for online merchants as compared to the “brick and mortar” merchants. For example, online merchants typically employ a mixture of purchased and internally developed software solutions and manage significant fraud operations and claims management departments. “Brick and mortar” merchants adopt different mitigation strategies, where in-person interactions with consumers are possible. The techniques used to commit fraud against merchants are ever-changing. Thus, fraud protection, adopted by merchants, needs to be constantly adapting to the ever-changing fraud techniques.

### BRIEF DESCRIPTION OF THE DRAWINGS

FIG. 1 is a diagram of an overview of an implementation described herein;

FIG. 2 is a diagram that illustrates an example environment in which systems and/or methods, described herein, may be implemented;

FIG. 3 is a diagram of example components of a device that may be used within the environment of FIG. 2;

FIG. 4 is a diagram of example functional units of the fraud management system of FIG. 2;

FIG. 5 is a diagram of example functional components of the fraud detection unit of FIG. 4;

FIG. 6 is a diagram of example libraries that may be present within the rules memory of FIG. 5;

FIG. 7 is a diagram of example functional components of the fraud detector of FIG. 5;

FIG. 8 is a diagram of example cases into which alarms may be placed by the alarm combiner and analyzer component of FIG. 7;

FIG. 9 is a diagram of example functional components of the fraud operations unit of FIG. 4;

FIG. 10 is a flowchart of an example process for analyzing instances of fraud; and

FIG. 11 is a diagram illustrating an example for identifying a fraudulent transaction.

### DETAILED DESCRIPTION OF PREFERRED EMBODIMENTS

The following detailed description refers to the accompanying drawings. The same reference numbers in different drawings may identify the same or similar elements.

An implementation, described herein, may detect fraudulent transactions by selectively applying rules designed for fraud detection. Rules may be selected based, for example, on information regarding the particular merchant from which the transactions were received; information regarding an industry (e.g., travel, financial, retail, medical, etc.) with which the particular merchant is associated; information regarding consumers that initiated the transactions; information regarding geographic locations associated with the transactions; or other transaction, merchant, or consumer related information. Some rules may be applicable to all transactions, while other rules may be specific to a set of transactions. Rules may be applied to a single transaction or may be applied across multiple transactions. Rules may also be applied for transactions of multiple unaffiliated merchants (e.g., merchants having no business relationships) or multiple unaffiliated consumers (e.g., consumers having no familial or other relationship). Fraud scores may be generated based on application of the rules and these fraud scores (or information generated based on the fraud scores) may be used by the merchants to determine whether to accept, deny, or fulfill a transaction.

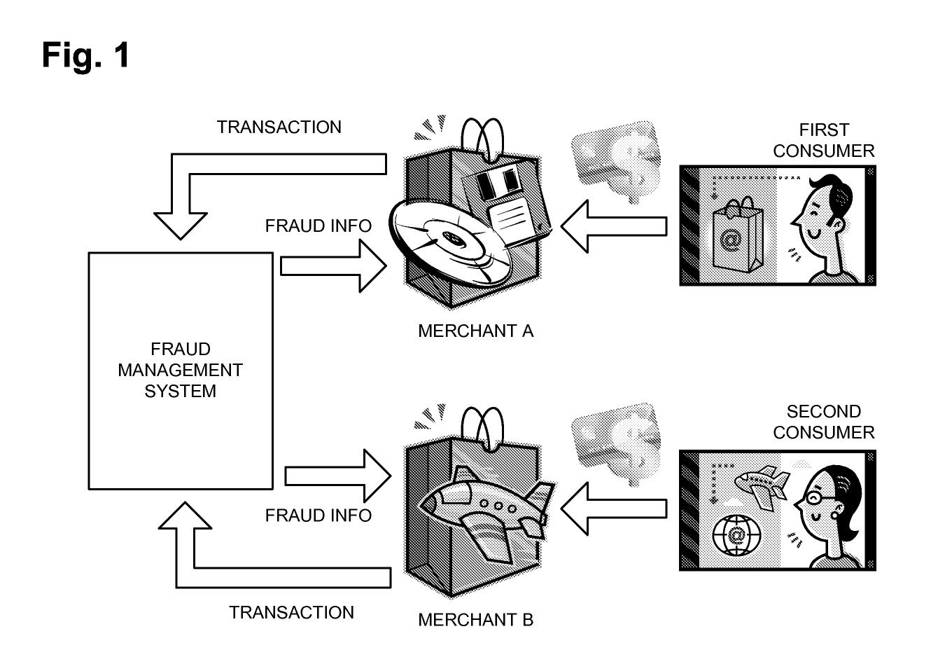

FIG. 1 is a diagram of an overview of an implementation described herein. For the example of FIG. 1, assume that a first consumer makes an online purchase of electronic goods via a website of a merchant (“merchant A”), and a second consumer makes an online purchase of airline tickets via a website of another merchant (“merchant B”). To complete the online purchase of the electronic goods, the first consumer may provide credit card information to merchant A. Likewise, to complete the online purchase of the airline tickets, the second consumer may provide credit card information to merchant B.

Merchants A and B may provide information regarding the transactions to a fraud management system. The term “transaction,” as used herein, is intended to be broadly interpreted to include an interaction of a consumer with a merchant. The interaction may involve the payment of money, a promise for a future payment of money, the deposit of money into an account, or the removal of money from an account. The term “money,” as used herein, is intended to be broadly interpreted to include anything that can be accepted as payment for goods or services, such as currency, coupons, credit cards, debit cards, gift cards, and funds held in a financial account (e.g., a checking account, a money market account, a savings account, a stock account, a mutual fund account, a paypal account, etc.). In one implementation, the transaction may involve a one time exchange of information, between the merchant and the fraud management system, which may occur at the completion of the interaction between the consumer and the merchant (e.g., when the consumer ends an online session with the merchant). In another implementation, the transaction may involve a series of exchanges of information, between the merchant and the fraud management system, which may occur during and/or after completion of the interaction between the consumer and the merchant.

The fraud management system may process the transactions using selected sets of rules to generate fraud information. For example, for the particular transaction involving the purchase of the electronic goods by the first consumer from merchant A, the fraud management system may select a set of rules that are applicable to the transaction; a set of rules that are applicable to merchant A; a set of rules that are applicable to the retail industry (with which merchant A is associated); a set of rules applicable to the first consumer; a set of rules applicable to the credit card information provided by the first consumer; a set of rules applicable to a geographic location associated with the first consumer or the transaction; and/or other applicable rules. The transaction may be analyzed alone and/or in combination with other transactions associated with merchant A, the first consumer, the credit card information provided by the first consumer, the geographic location, etc.

For the particular transaction involving the purchase of the airline tickets by the second consumer from merchant B, the fraud management system may select a set of rules that are applicable to the transaction; a set of rules that are applicable to merchant B; a set of rules that are applicable to the travel industry (of which merchant B is a part); a set of rules applicable to the second consumer; a set of rules applicable to the credit card information provided by the second consumer; a set of rules applicable to a geographic location associated with the second consumer or the transaction; and/or other applicable rules. The transaction may be analyzed alone and/or in combination with other transactions associated with merchant B, the second consumer, the credit card information provided by the second consumer, the geographic location, etc.

The fraud management system may generate fraud information for the transactions and may output the fraud information to merchants A and B to inform merchants A and B whether the transactions potentially involved fraud. The fraud information may take the form of a fraud score or may take the form of an “accept” alert (meaning that the transaction is not fraudulent) or a “reject” alert (meaning that the transaction is potentially fraudulent). Merchants A and B may then decide whether to permit or deny the transaction, or proceed to fulfill the goods or services secured in the transaction, based on the fraud information. In the description to follow, the phrase “fulfill the transaction,” or the like, is intended to refer to fulfilling the goods or services secured in the transaction.

In the example of FIG. 1, assume that the first and second consumers provide the same credit card number. This alone may not be sufficient to determine that the transactions are potentially fraudulent. But now suppose that the first consumer is located in Arizona and the second consumer is located in Brazil and that the transactions occurred within 10 minutes of each other. When all of this information is considered, the fraud detection system may determine that the transactions are potentially fraudulent and may inform merchants A and B of this determination. As a result, merchants A and B may take measures to minimize their risk of fraud.

In some scenarios, the fraud management system may detect potential fraud in near real-time (i.e., while the transactions are occurring). In other scenarios, the fraud management system may detect potential fraud after conclusion of the transactions (perhaps minutes, hours, or days later). In either scenario, the fraud management system may reduce revenue loss contributable to fraud. In addition, the fraud management system may help reduce merchant costs in terms of software, hardware, and personnel dedicated to fraud detection and prevention.

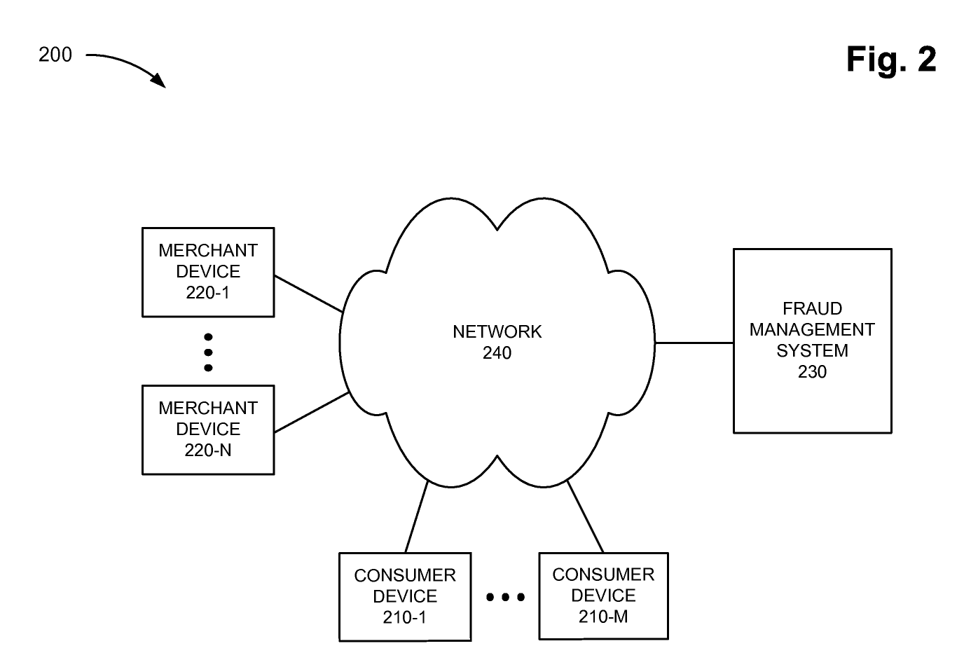

FIG. 2 is a diagram that illustrates an example environment 200 in which systems and/or methods, described herein, may be implemented. As shown in FIG. 2, environment 200 may include consumer devices 210-1, . . . , 210-M (where M≧1) (collectively referred to as “consumer devices 210,” and individually as “consumer device 210”), merchant devices 220-1, . . . , 220-N (where N≧1) (collectively referred to as “merchant devices 220,” and individually as “merchant device 220”), fraud management system 230, and network 240.

While FIG. 2 shows a particular number and arrangement of devices, in practice, environment 200 may include additional devices, fewer devices, different devices, or differently arranged devices than are shown in FIG. 2. Also, although certain connections are shown in FIG. 2, these connections are simply examples and additional or different connections may exist in practice. Each of the connections may be a wired and/or wireless connection. Further, each consumer device 210 and merchant device 220 may be implemented as multiple, possibly distributed, devices. Alternatively, a consumer device 210 and a merchant device 220 may be implemented within a single device.

Consumer device 210 may include any device capable of interacting with a merchant device 220 to perform a transaction. For example, consumer device 210 may correspond to a communication device (e.g., a mobile phone, a smartphone, a personal digital assistant (PDA), or a wireline telephone), a computer device (e.g., a laptop computer, a tablet computer, or a personal computer), a gaming device, a set top box, or another type of communication or computation device. As described herein, a user, of a consumer device 210, may use consumer device 210 to perform a transaction with regard to a merchant device 220.

Merchant device 220 may include a device, or a collection of devices, capable of interacting with a consumer device 210 to perform a transaction. For example, merchant device 220 may correspond to a computer device (e.g., a server, a laptop computer, a tablet computer, or a personal computer). Additionally, or alternatively, merchant device 220 may include a communication device (e.g., a mobile phone, a smartphone, a PDA, or a wireline telephone) or another type of communication or computation device. As described herein, merchant device 220 may interact with a consumer device 210 to perform a transaction and may interact with fraud management system 230 to determine whether that transaction is potentially fraudulent.

Fraud management system 230 may include a device, or a collection of devices, that performs fraud analysis. Fraud management system 230 may receive transaction information from merchant devices 220, perform fraud analysis with regard to the transaction information, and provide, to merchant devices 220, information regarding the results of the fraud analysis.

Network 240 may include any type of network or a combination of networks. For example, network 240 may include a local area network (LAN), a wide area network (WAN) (e.g., the Internet), a metropolitan area network (MAN), an ad hoc network, a telephone network (e.g., a Public Switched Telephone Network (PSTN), a cellular network, or a voice-over-IP (VoIP) network), an optical network (e.g., a FiOS network), or a combination of networks. In one implementation, network 240 may support secure communications between merchants 220 and fraud management system 230. These secure communications may include encrypted communications, communications via a private network (e.g., a virtual private network (VPN) or a private IP VPN (PIP VPN)), other forms of secure communications, or a combination of secure types of communications.

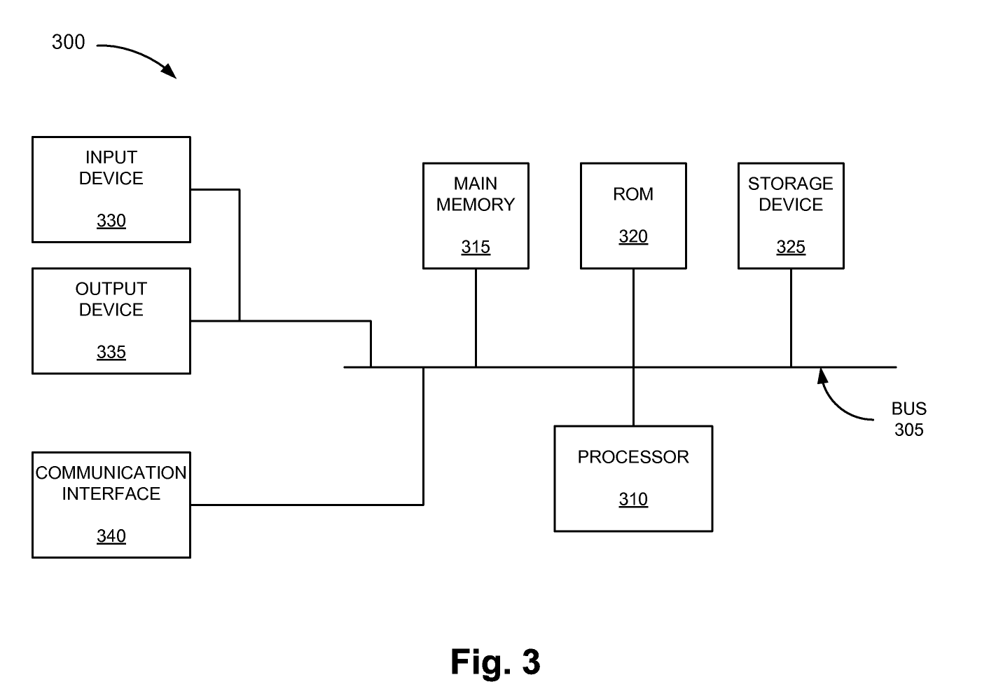

FIG. 3 is a diagram of example components of a device 300. Device 300 may correspond to consumer device 210, merchant device 220, or fraud management system 230. Each of consumer device 210, merchant device 220, and fraud management system 230 may include one or more devices 300.

As shown in FIG. 3, device 300 may include a bus 305, a processor 310, a main memory 315, a read only memory (ROM) 320, a storage device 325, an input device 330, an output device 335, and a communication interface 340. In another implementation, device 300 may include additional components, fewer components, different components, or differently arranged components.

Bus 305 may include a path that permits communication among the components of device 300. Processor 310 may include one or more processors, one or more microprocessors, one or more application specific integrated circuits (ASICs), one or more field programmable gate arrays (FPGAs), or one or more other types of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a mechanism that permits an operator to input information to device 300, such as a control button, a keyboard, a keypad, or another type of input device. Output device 335 may include a mechanism that outputs information to the operator, such as a light emitting diode (LED), a display, or another type of output device. Communication interface 340 may include any transceiver-like mechanism that enables device 300 to communicate with other devices or networks (e.g., network 240). In one implementation, communication interface 340 may include a wireless interface and/or a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include space within a single physical memory device or spread across multiple physical memory devices.

The software instructions may be read into main memory 315 from another computer-readable medium, such as storage device 325, or from another device via communication interface 340. The software instructions contained in main memory 315 may cause processor 310 to perform processes that will be described later. Alternatively, hardwired circuitry may be used in place of or in combination with software instructions to implement processes described herein. Thus, implementations described herein are not limited to any specific combination of hardware circuitry and software.

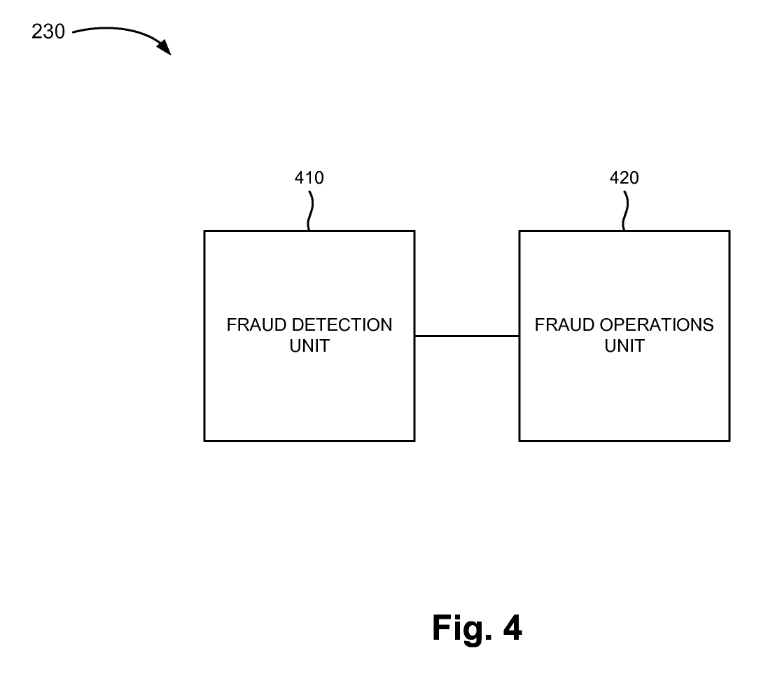

FIG. 4 is a diagram of example functional units of fraud management system 230. In one implementation, the functions described in connection with FIG. 4 may be performed by one or more components of device 300 (FIG. 3) or one or more devices 300, unless described as being performed by a human.

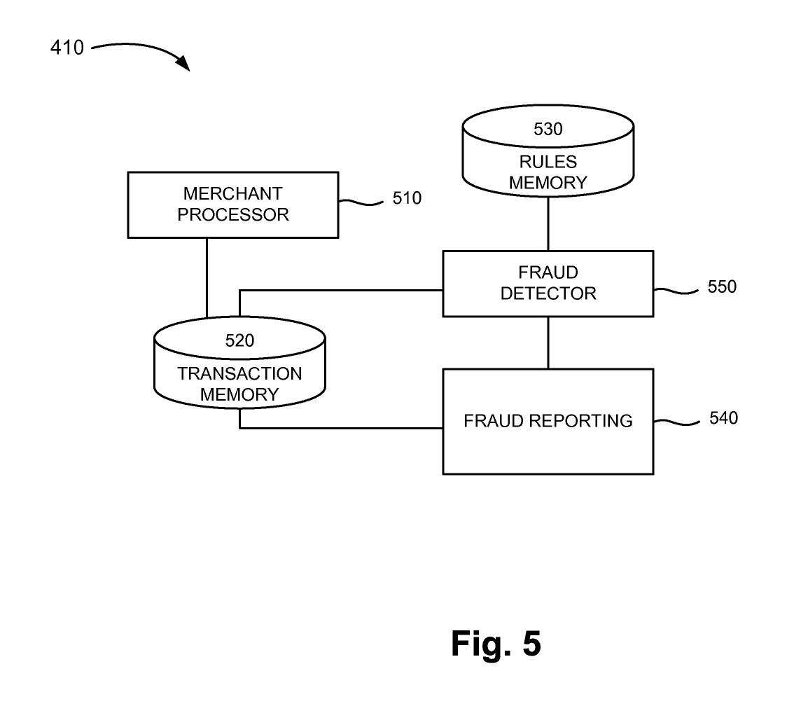

As shown in FIG. 4, fraud management system 230 may include fraud detection unit 410 and fraud operations unit 420. In another implementation, fraud management system 230 may include fewer, additional, or different functional units. Fraud detection unit 410 and fraud operations unit 420 will be described generally with regard to FIG. 4 and will be described in more detail with regard to FIGS. 5-9.

Generally, fraud detection unit 410 may receive information regarding transactions from merchant devices 220 and analyze the transactions to determine whether the transactions are potentially fraudulent. In one implementation, fraud detection unit 410 may classify a transaction as: “safe,” “unsafe,” or “for review.” A “safe” transaction may include a transaction with a fraud score that is less than a first threshold (e.g., less than 5, less than 10, less than 20, etc. within a range of fraud scores of 0 to 100, where a fraud score of 0 may represent a 0% probability that the transaction is fraudulent and a fraud score of 100 may represent a 100% probability that the transaction is fraudulent). An “unsafe” transaction may include a transaction with a fraud score that is greater than a second threshold (e.g., greater than 90, greater than 80, greater than 95, etc. within the range of fraud scores of 0 to 100) (where the second threshold is greater than the first threshold). A “for review” transaction may include a transaction with a fraud score that is greater than a third threshold (e.g., greater than 50, greater than 40, greater than 60, etc. within the range of fraud scores of 0 to 100) and not greater than the second threshold (where the third threshold is greater than the first threshold and less than the second threshold). In one implementation, the first, second, and third thresholds and the range of potential fraud scores may be set by an operator of fraud management system 230. In another implementation, the first, second, and/or third thresholds and/or the range of potential fraud scores may be set by a merchant. In this case, the thresholds and/or range may vary from merchant-to-merchant. The fraud score may represent a probability that a transaction is fraudulent.

If fraud detection unit 410 determines that a transaction is a “safe” transaction, fraud detection unit 410 may notify a merchant device 220 that merchant device 220 may safely approve, or alternatively fulfill, the transaction. If fraud detection unit 410 determines that a transaction is an “unsafe” transaction, fraud detection unit 410 may notify a merchant device 220 to take measures to minimize the risk of fraud (e.g., deny the transaction, request additional information from a consumer device 210, require interaction with a human operator, refuse to fulfill the transaction, etc.). Alternatively, or additionally, fraud detection unit 410 may provide information regarding the unsafe transaction to fraud operations unit 420 for additional processing of the transaction. If fraud detection unit 410 determines that a transaction is a “for review” transaction, fraud detection unit 410 may provide information regarding the transaction to fraud operations unit 420 for additional processing of the transaction.

Generally, fraud operations unit 420 may receive information regarding certain transactions and may analyze these transactions to determine whether a determination can be made whether the transactions are fraudulent. In one implementation, human analyzers may use various research tools to investigate transactions and determine whether the transactions are fraudulent.

FIG. 5 is a diagram of example functional components of fraud detection unit 410. In one implementation, the functions described in connection with FIG. 5 may be performed by one or more components of device 300 (FIG. 3) or one or more devices 300. As shown in FIG. 5, fraud detection unit 410 may include a merchant processor component 510, a transaction memory 520, a rules memory 530, a fraud reporting component 540, and a fraud detector component 550. In another implementation, fraud detection unit 410 may include fewer functional components, additional functional components, different functional components, or differently arranged functional components.

Merchant processor component 510 may include a device, or a collection of devices, that may interact with new merchants to assist the new merchants in using fraud management system 230. For example, merchant processor component 510 may exchange encryption information, such as public/private keys or VPN information, with a merchant device 220 to permit secure future communications between fraud detection system 230 and merchant device 220.

Merchant processor component 510 may receive, from the merchant or merchant device 220, information that might be useful in detecting a fraudulent transaction. For example, merchant processor component 510 may receive a black list (e.g., a list of consumers or consumer devices 210 that are known to be associated with fraudulent activity) and/or a white list (e.g., a list of consumers or consumer devices 210 that are known to be particularly trustworthy). Additionally, or alternatively, merchant processor component 510 may receive historical records of transactions from the merchant or merchant device 220. These historical records may include information regarding transactions that were processed by a system other than fraud management system 230. Additionally, or alternatively, merchant processor component 510 may receive a set of policies from the merchant or merchant device 220. The policies may indicate thresholds for determining safe transactions, unsafe transactions, and for review transactions, may indicate a range of possible fraud scores (e.g., range of 0 to 100, range of 0 to 1000, etc.), or may indicate other business practices of the merchant. Additionally, or alternatively, merchant processor component 510 may receive a set of rules that are particular to the merchant.

Transaction memory 520 may include one or more memory devices to store information regarding present and/or past transactions. Present transactions may include transactions currently being processed by fraud detector component 550, and past transactions may include transactions previously processed by fraud detector component 550. In one implementation, transaction memory 520 may store data in the form of a database, such as a relational database or an object-oriented database. In another implementation, transaction memory 520 may store data in a non-database manner, such as as tables, linked lists, or another arrangement of data.

Transaction memory 520 may store various information for any particular transaction. For example, transaction memory 520 might store: information identifying a consumer or a consumer device 210 (e.g., a consumer device ID, an IP address associated with the consumer device, a telephone number associated with the consumer device, a username associated with the consumer, a consumer ID, etc.); information identifying a merchant or a merchant device 220 (e.g., a merchant ID, merchant name, merchant device ID, etc.); information identifying an industry with which the merchant is associated (e.g., retail, medical, travel, financial, etc.); a name, telephone number, and address associated with the consumer; information regarding consumer device 210 (e.g., an IP address associated with the consumer device, a type/version of browser used by the consumer device, cookie information associated with the consumer device, a type/version of an operating system used by the consumer device, etc.); a dollar amount of the transaction; line items of the transaction (e.g., identification of each good/service purchased, each leg of an airplane flight booked, etc.); information regarding a form of payment received from the consumer (e.g., credit card information, debit card information, checking account information, paypal account information, etc.); a day and/or time that the transaction occurred (e.g., 13:15 on Nov. 5, 2010); a geographic location associated with the transaction or the consumer (e.g., a destination location associated with a form of travel, an origination location associated with a form of travel, a location of a hotel for which a room was reserved, a location of a residence of the consumer, etc.), and/or other types of information associated with the transaction, the merchant, the merchant device 220, the consumer, or the consumer device 210, and/or a past transaction associated with the merchant, the merchant device 220, the consumer, or the consumer device 210.

Transaction memory 520 may also store other information that might be useful in detecting a fraudulent transaction. For example, transaction memory 520 may store black lists and/or white lists. The black/white lists may be particular to a merchant or an industry or may be applicable across merchants or industries. The black/white lists may be received from merchants or may be generated by fraud management system 230.

Transaction memory 520 may also store historical records of transactions from a merchant. These historical records may include transactions that were processed by a system other than fraud management system 230. The historical records may include information similar to the information identified above and may also include information regarding transactions that the merchant had identified as fraudulent.

Rules memory 530 may include one or more memory devices to store information regarding rules that may be applicable to transactions. In one implementation, rules memory 530 may store rules in one or more libraries. A “library” may be a block of memory locations (contiguous or non-contiguous memory locations) that stores a set of related rules. In another implementation, rules memory 530 may store rules in another manner (e.g., as database records, tables, linked lists, etc.).

The rules may include general rules, merchant-specific rules, industry-specific rules, consumer-specific rules, transaction attribute specific rules, single transaction rules, multi-transaction rules, heuristic rules, pattern recognition rules, and/or other types of rules. Some rules may be applicable to all transactions (e.g., general rules may be applicable to all transactions), while other rules may be applicable to a specific set of transactions (e.g., merchant-specific rules may be applicable to transactions associated with a particular merchant). Rules may be used to process a single transaction (meaning that the transaction may be analyzed for fraud without considering information from another transaction) or may be used to process multiple transactions (meaning that the transaction may be analyzed for fraud by considering information from another transaction). Rules may also be applicable to multiple, unaffiliated merchants (e.g., merchants having no business relationships) or multiple, unrelated consumers (e.g., consumers having no familial or other relationship).

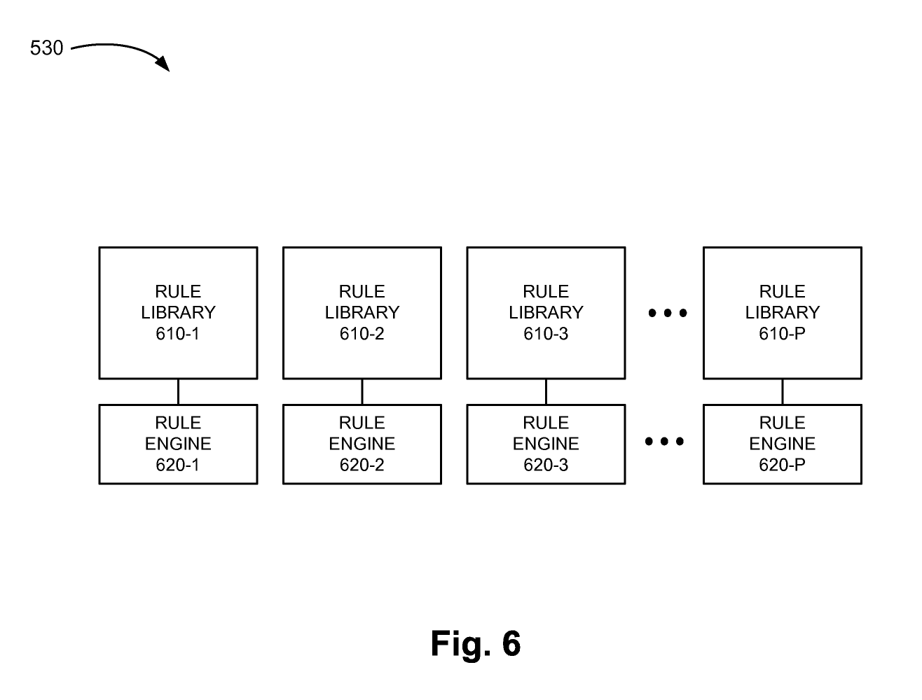

FIG. 6 is a diagram of example libraries that may be present within rules memory 530. As shown in FIG. 6, rules memory 530 may include rule libraries 610-1, 610-2, 610-3, . . . 610-P (P≧1) (collectively referred to as “libraries 610,” and individually as “library 610”) and rule engines 620-1, 620-2, 620-3, . . . 620-P (collectively referred to as “rule engines 620,” and individually as “rule engine 620”). While FIG. 6 illustrates that rules memory 530 includes a set of rule libraries 610 and a corresponding set of rule engines 620, rules memory 530 may include fewer, additional, or different components in another implementation.

Each rule library 610 may store a set of related rules. For example, a rule library 610 may store general rules that are applicable to all transactions. Additionally, or alternatively, a rule library 610 may store rules applicable to a single transaction (meaning that the transaction may be analyzed for fraud without considering information from another transaction). Additionally, or alternatively, a rule library 610 may store rules applicable to multiple transactions (meaning that the transaction may be analyzed for fraud by considering information from another transaction (whether from the same merchant or a different merchant, whether associated with the same consumer or a different consumer)).

Additionally, or alternatively, a rule library 610 may store merchant-specific rules. Merchant-specific rules may include rules that are applicable to transactions of a particular merchant, and not applicable to transactions of other merchants. Additionally, or alternatively, a rule library 610 may store industry-specific rules. Industry-specific rules may include rules that are applicable to transactions associated with a particular industry of merchants (e.g., financial, medical, retail, travel, etc.), and not applicable to transactions associated with other industries. Additionally, or alternatively, a rule library 610 may store consumer-specific rules. Consumer-specific rules may include rules that are applicable to transactions of a particular consumer or a particular set of consumers (e.g., all consumers in the consumer's family, all consumers located at a particular geographic location, all consumers located within a particular geographic region, all consumers using a particular type of browser or operating system, etc.), and not applicable to transactions of other consumers or sets of consumers.

Additionally, or alternatively, a rule library 610 may store location-specific rules. Location-specific rules may include rules that are applicable to transactions associated with a particular geographic area (e.g., an origination location associated with a travel itinerary, a destination location associated with a travel itinerary, a location from which a transaction originated, etc.), and not applicable to transactions associated with other geographic areas. Additionally, or alternatively, a rule library 610 may store rules associated with a particular transaction attribute, such as a dollar amount or range, a name of a traveler, a telephone number, etc.

The rules in rule libraries 610 may include human-generated rules and/or automatically-generated rules. The automatically-generated rules may include heuristic rules and/or pattern recognition rules. Heuristic rules may include rules that have been generated by using statistical analysis, or the like, that involves analyzing a group of attributes (e.g., a pair of attributes or a tuple of attributes) of transactions, and learning rules associated with combinations of attributes that are indicative of fraudulent transactions. Pattern recognition rules may include rules that have been generated using machine learning, artificial intelligence, neural networks, decision trees, or the like, that analyzes patterns appearing in a set of training data, which includes information regarding transactions that have been identified as fraudulent and information regarding transactions that have been identified as non-fraudulent, and generates rules indicative of patterns associated with fraudulent transactions.

In other implementations, rule libraries 610 may store other types of rules, other combinations of rules, or differently-generated rules. Because fraud techniques are constantly changing, the rules, in rule libraries 610, may be regularly updated (either by manual or automated interaction) by modifying existing rules, adding new rules, and/or removing antiquated rules.

Each rule engine 620 may correspond to a corresponding rule library 610. A rule engine 620 may receive a transaction from fraud detector component 550, coordinate the execution of the rules by the corresponding rule library 610, and return the results (in the form of zero or more alarms) to fraud detector component 550. In one implementation, rule engine 620 may cause a transaction to be processed by a set of rules within the corresponding rule library 610 in parallel. In other words, the transaction may be concurrently processed by multiple, different rules in a rule library 610 (rather than serially processed).

Returning to FIG. 5, fraud reporting component 540 may include a device, or a collection of devices, that generates reports for merchants. For example, a merchant may request a particular report relating to transactions that the merchant sent to fraud management system 230. The report may provide information regarding the analysis of various transactions and may be tailored, by the merchant, to include information that the merchant desires. Fraud reporting component 540 may be configured to generate reports periodically, only when prompted, or at any other interval specified by a merchant.

Fraud detector component 550 may include a device, or a collection of devices, that performs automatic fraud detection on transactions. Fraud detector component 550 may receive a transaction from a particular merchant device 220 and select particular libraries 610 and particular rules within the selected libraries 610 applicable to the transaction. Fraud detector component 550 may then provide the transaction for processing by the selected rules in the selected libraries 610 in parallel. The output of the processing, by the selected libraries 610, may include zero or more alarms. An “alarm,” as used herein, is intended to be broadly interpreted as a triggering of a rule in a library 610. A rule is triggered when the transaction satisfies the rule. For example, assume that a rule indicates a situation where a consumer reserves a hotel room in the same geographic area in which the consumer lives. A transaction would trigger (or satisfy) the rule if the transaction involved a consumer making a reservation for a hotel room in the town where the consumer lives.

Fraud detector component 550 may sort and group the alarms and analyze the groups to generate a fraud score. The fraud score may reflect the probability that the transaction is fraudulent. Fraud detector component 550 may send the fraud score, or an alert generated based on the fraud score, to a merchant device 220. The alert may simply indicate that merchant device 220 should accept, deny, or fulfill the transaction. In one implementation, the processing by fraud detector component 550 from the time that fraud detector component 550 receives the transaction to the time that fraud detector component 550 sends the alert may be within a relatively short time period, such as, for example, within thirty seconds, sixty seconds, or ten seconds. In another implementation, the processing by fraud detector component 550 from the time that fraud detector component 550 receives the transaction to the time that fraud detector component 550 sends the alert may be within a relatively longer time period, such as, for example, within minutes, hours or days.

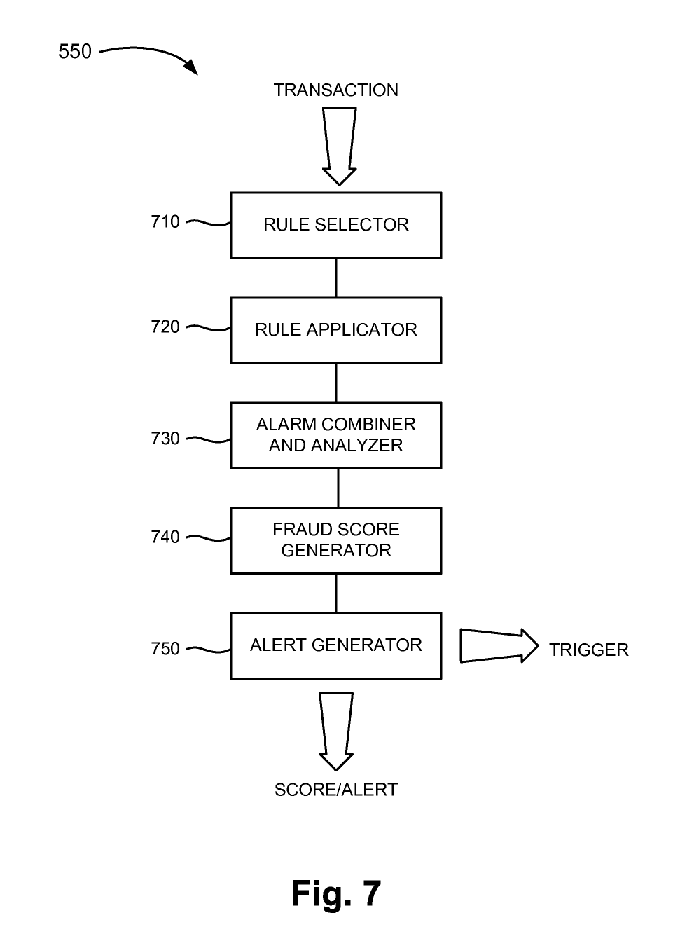

FIG. 7 is a diagram of example functional components of fraud detector component 550. In one implementation, the functions described in connection with FIG. 7 may be performed by one or more components of device 300 (FIG. 3) or one or more devices 300. As shown in FIG. 7, fraud detector component 550 may include a rule selector component 710, a rule applicator component 720, an alarm combiner and analyzer component 730, a fraud score generator component 740, and an alert generator component 750. In another implementation, fraud detector component 550 may include fewer functional components, additional functional components, different functional components, or differently arranged functional components.

Rule selector component 710 may receive a transaction from a merchant device 220. In one implementation, the transaction may include various information, such as information identifying a consumer (e.g., name, address, telephone number, etc.); a total dollar amount of the transaction; a name of a traveler (in the case of a travel transaction); line items of the transaction (e.g., information identifying a good or service purchased or rented, origination, destination, and intermediate stops of travel, etc.); information identifying a merchant (e.g., merchant name or merchant identifier); information regarding a form of payment received from the consumer (e.g., credit card information, debit card information, checking account information, paypal account information, etc.); and information identifying a day and/or time that the transaction occurred (e.g., 13:15 on Nov. 5, 2010).

Additionally, or alternatively, rule selector component 710 may receive other information (called “meta information”) from the merchant in connection with the transaction. For example, the meta information may include information identifying a consumer device 210 (e.g., a consumer device ID, an IP address associated with the consumer device, a telephone number associated with the consumer device, etc.); other information regarding consumer device 210 (e.g., an IP address associated with the consumer device, a type/version of browser used by the consumer device, cookie information associated with the consumer device, a type/version of an operating system used by the consumer device, etc.); and/or other types of information associated with the transaction, the merchant, the merchant device 220, the consumer, or the consumer device 210.

Additionally, or alternatively, rule selector component 710 may receive or obtain other information (called “third party information”) regarding the transaction, the merchant, the merchant device 220, the consumer, or the consumer device 210. For example, the other information may include a geographic identifier (e.g., zip code or area code) that may correspond to the IP address associated with consumer device 210. The other information may also, or alternatively, include information identifying an industry with which the merchant is associated (e.g., retail, medical, travel, financial, etc.). Rule selector component 710 may obtain the third party information from a memory or may use research tools, such an IP address-to-geographic location identifier look up tool or a merchant name-to-industry look up tool.

Additionally, or alternatively, rule selector component 710 may receive or obtain historical information regarding the merchant, the merchant device 220, the consumer, the consumer device 210, or information included in the transaction. In one implementation, rule selector component 710 may obtain the historical information from transaction memory 520 (FIG. 5).

The transaction information, the meta information, the third party information, and/or the historical information may be individually referred to as a “transaction attribute” or an “attribute of the transaction,” and collectively referred to as “transaction attributes” or “attributes of the transaction.”

Rule selector component 710 may generate a profile for the transaction based on the transaction attributes. Based on the transaction profile and perhaps relevant information in a white or black list (i.e., information, relevant to the transaction, that is present in a white or black list), rule selector component 710 may select a set of libraries 610 within rules memory 530 and/or may select a set of rules within one or more of the selected libraries 610. For example, rule selector component 710 may select libraries 610, corresponding to general rules, single transaction rules, multi-transaction rules, merchant-specific rules, industry-specific rules, etc., for the transaction.

Rule applicator component 720 may cause the transaction to be processed using rules of the selected libraries 610. For example, rule applicator component 720 may provide information regarding the transaction to rule engines 620 corresponding to the selected libraries 610. Each rule engine 620 may process the transaction in parallel and may process the transaction using all or a subset of the rules in the corresponding library 610. The transaction may be concurrently processed by different sets of rules (of the selected libraries 610 and/or within each of the selected libraries 610). The output, of each of the selected libraries 610, may include zero or more alarms. As explained above, an alarm may be generated when a particular rule is triggered (or satisfied).

Alarm combiner and analyzer component 730 may collect and sort the alarms. For example, alarm combiner and analyzer component 730 may analyze attributes of the transaction(s) with which the alarms are associated (e.g., attributes relating to a form of payment, an IP address, a travel destination, etc.). Alarm combiner and analyzer component 730 may sort the alarms, along with alarms of other transactions (past or present), into groups (called “cases”) based on values of one or more of the attributes of the transactions associated with the alarms (e.g., credit card numbers, IP addresses, geographic locations, consumer names, etc.). The transactions, included in a case, may involve one merchant or multiple, unaffiliated merchants and/or one consumer or multiple, unrelated consumers.

Alarm combiner and analyzer component 730 may separate alarms (for all transactions, transactions sharing a common transaction attribute, or a set of transactions within a particular window of time) into one or more cases based on transaction attributes. For example, alarm combiner and analyzer component 730 may place alarms associated with a particular credit card number into a first case, alarms associated with another particular credit card number into a second case, alarms associated with a particular IP address into a third case, alarms associated with a consumer or consumer device 210 into a fourth case, alarms associated with a particular merchant into a fifth case, alarms associated with a particular geographic location into a sixth case, etc. A particular alarm may be included in multiple cases.

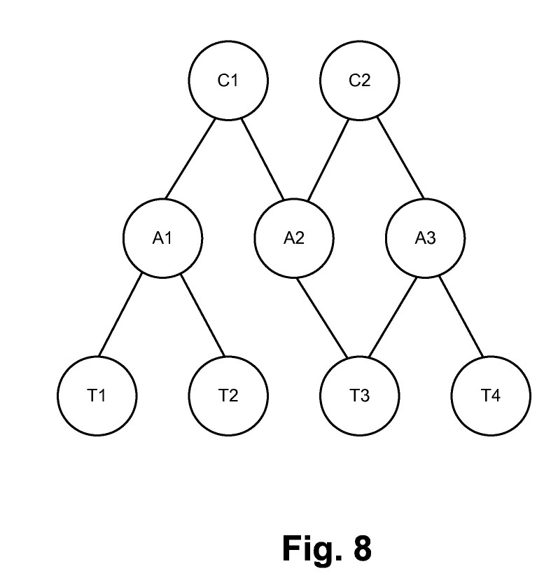

FIG. 8 is a diagram of example cases into which alarms may be placed by alarm combiner and analyzer component 730. As shown in FIG. 8, assume that fraud detector component 550 receives four transactions T1-T4. By processing each of transactions T1-T4 using rules in select libraries 610, zero or more alarms may be generated. As shown in FIG. 8, assume that three alarms A1-A3 are generated. An alarm may be an aggregation of one or more transactions (e.g., alarm A1 is the aggregation of transactions T1 and T2; alarm A2 is the aggregation of transaction T3; and alarm A3 is the aggregation of transactions T3 and T4) that share a common attribute. The alarms may be correlated into cases. As shown in FIG. 8, assume that two cases C1 and C2 are formed. A case is a correlation of one or more alarms (e.g., case C1 is the correlation of alarms A1 and A2; and case C2 is the correlation of alarms A2 and A3) that share a common attribute.

An individual alarm may not be sufficient evidence to determine that a transaction is fraudulent. When the alarm is correlated with other alarms in a case, then a clearer picture of whether the transaction is fraudulent may be obtained. Further, when multiple cases involving different attributes of the same transaction are analyzed, then a decision may be made whether a transaction is potentially fraudulent.

Returning to FIG. 7, fraud score generator component 740 may generate a fraud score. Fraud score generator component 740 may generate a fraud score from information associated with one or more cases (each of which may include one or more transactions and one or more alarms). In one implementation, fraud score generator component 740 may generate an alarm score for each generated alarm. For example, each of the transaction attributes and/or each of the rules may have a respective associated weight value. Thus, when a particular transaction attribute causes a rule to trigger, the generated alarm may have a particular score based on the weight value of the particular transaction attribute and/or the weight value of the rule. When a rule involves multiple transactions, the generated alarm may have a particular score that is based on a combination of the weight values of the particular transaction attributes.

In one implementation, fraud score generator component 740 may generate a case fraud score for a case by combining the alarm scores in some manner. For example, fraud score generator component 740 may generate a case score (CS) by using a log-based Naïve Bayesian algorithm, such as:

$$CS = \frac{{\sum }_{i} \frac{{AS}_{i} \times {AW}_{i}}{{AM}_{i}}}{{\sum }_{i} {AW}_{i}} \times 1000 ,$$

where CS may refer to the fraud score for a case, ASᵢ may refer to an alarm score for a given value within an alarm i, AWᵢ may refer to a relative weight given to alarm i, and AMᵢ may refer to a maximum score value for alarm i. The following equation may be used to calculate ASᵢ when the score for the alarm involves a list (e.g., more than one alarm in the case):

ASᵢ=1−(1−sᵢ)×(1−s₂)×(1−sₙ).

Alternatively, fraud score generator component 740 may generate a case score using an equation, such as:

$$CS = {\sum }_{k = 1}^{m} {AS}_{k} , or$$

$$CS = {\sum }_{k = 1}^{m} {AS}_{k} \times {AW}_{k} .$$

Fraud score generator component 740 may generate a fraud score for a transaction by combining the case scores in some manner. For example, fraud score generator component 740 may generate the fraud score (FS) using an equation, such as:

$$FS = {\sum }_{k = 1}^{n} {CS}_{k} .$$

In another implementation, each case may have an associated weight value. In this situation, fraud score generator component 740 may generate the fraud score using an equation, such as:

$$FS = {\sum }_{k = 1}^{n} {CS}_{k} \times {CW}_{k} ,$$

where CW may refer to a weight value for a case.

Alert generator component 750 may generate an alert and/or a trigger based, for example, on the fraud score. In one implementation, alert generator component 750 may classify the transaction, based on the fraud score, into: safe, unsafe, or for review. As described above, fraud detection unit 410 may store policies for a particular merchant that indicate, among other things, the thresholds that are to be used to classify a transaction as safe, unsafe, or for review. When the transaction is classified as safe or unsafe, alert generator component 750 may generate and send the fraud score and/or an alert (e.g., safe/unsafe or accept/deny) to the merchant so that the merchant can make an intelligent decision as to whether to accept, deny, or fulfill the transaction. When the transaction is classified as for review, alert generator component 750 may generate and send a trigger to fraud operations unit 420 so that fraud operations unit 420 may perform further analysis regarding a transaction or a set of transactions associated with a case.

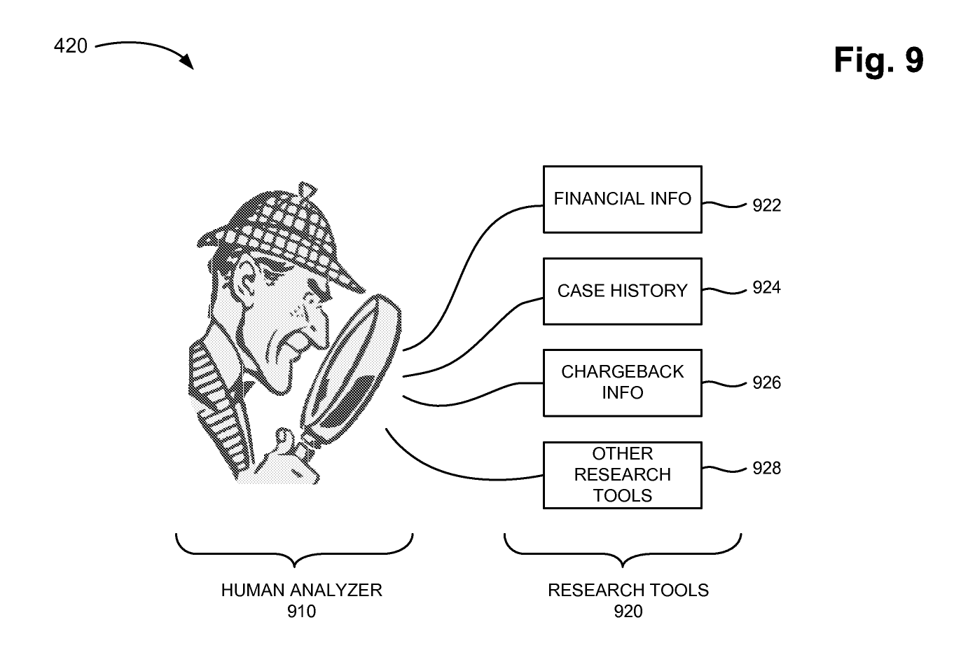

FIG. 9 is a diagram of example functional components of fraud operations unit 420. In one implementation, the functions described in connection with FIG. 9 may be performed by one or more components of device 300 (FIG. 3) or one or more devices 300, unless described as being performed by a human. As shown in FIG. 9, fraud operations unit 420 may include a human analyzer 910 and a set of research tools 920. In another implementation, fraud operations unit 420 may include fewer, additional, or different functional components.

Human analyzer 910 may include a person, or a set of people, trained to research and detect fraudulent transactions. Human analyzer 910 may analyze for review transactions (e.g., transactions included in consolidated cases) and perform research to determine whether the transactions are fraudulent. Additionally, or alternatively, human analyzer 910 may perform trending analysis, perform feedback analysis, modify existing rules, and/or create new rules. Human analyzer 910 may record the results of transaction analysis and may present the results to fraud detection unit 410 and/or one or more merchant devices 220. Human analyzer 910 may cause modified rules and/or new rules to be stored in appropriate libraries 610.

Research tools 920 may include financial information 922, case history 924, chargeback information 926, and other research tools 928. Financial information 922 may include financial data and tools. Case history 924 may include a repository of previously analyzed cases. In one implementation, case history 924 may store a repository of cases for some period of time, such as six months, a year, two years, five years, etc. Chargeback information 926 may include information regarding requests for reimbursements (commonly referred to as “chargebacks”) from a financial institution when the financial institution identifies a fraudulent transaction. When the financial institution identifies a fraudulent transaction, the financial institution may contact the merchant that was involved in the transaction and indicate, to the merchant, that the merchant's account is going to be debited for the amount of the transaction and perhaps have to pay a penalty fee. Other research tools 928 may include reverse telephone number look up tools, address look up tools, white pages tools, Internet research tools, etc. which may facilitate the determination of whether a transaction is fraudulent.

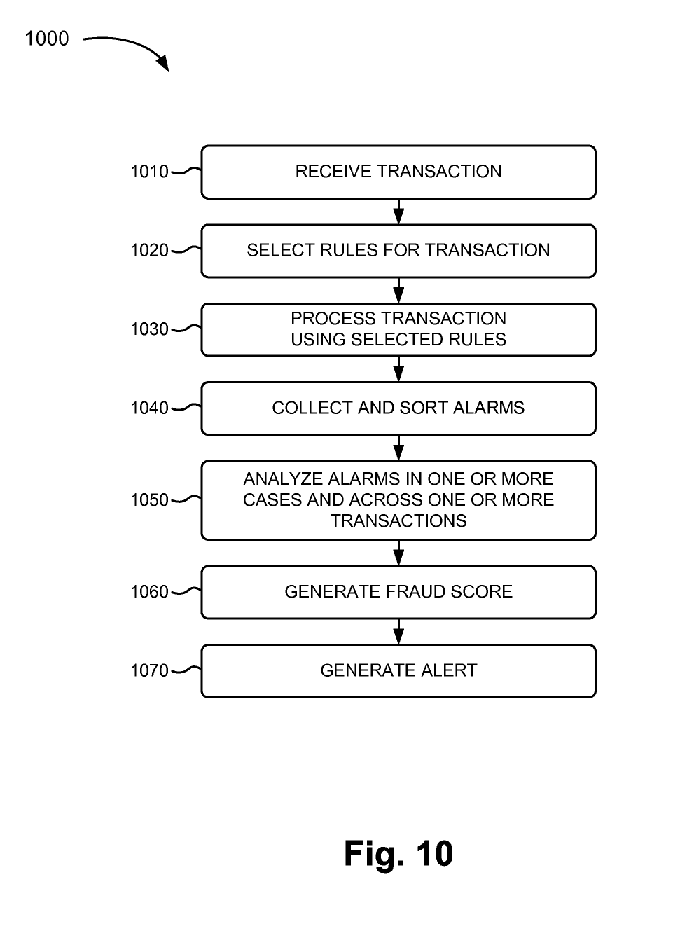

FIG. 10 is a flowchart of an example process 1000 for analyzing instances of fraud. In one implementation, process 1000 may be performed by one or more components/devices of fraud management system 230. In another implementation, one or more blocks of process 1000 may be performed by one or more other components/devices, or a group of components/devices including or excluding fraud management system 230.

Process 1000 may include receiving a transaction (block 1010). For example, fraud detector component 550 may receive a transaction from a merchant device 220. Merchant device 220 may use secure communications, such as encryption or a VPN, to send the transaction to fraud management system 230. In one implementation, merchant device 220 may send the transaction to fraud management system 230 in near real time (e.g., when a consumer submits money to the merchant for the transaction) and perhaps prior to the money being accepted by the merchant. In another implementation, merchant device 220 may send the transaction to fraud management system 230 after the money, for the transaction, has been accepted by the merchant (e.g., after the money has been accepted but prior to a product or service, associated with the transaction, being fulfilled, or possibly after the money has been accepted and after the product or service, associated with the transaction, has been fulfilled). In practice, fraud management system 230 may simultaneously receive information regarding multiple transactions from one or more merchant devices 220.

Rules may be selected for the transaction (block 1020). For example, fraud detector component 550 may generate a profile for the transaction based on transaction attributes (e.g., information in the transaction itself, meta information associated with the transaction, third party information associated with the transaction, and/or historical information associated with one or more attributes of the transaction). Fraud detector component 550 may use the profile and relevant information in a black or white list (if any information, relevant to the transaction, exists in a black or white list) to select a set of libraries 610 and/or a set of rules within one or more libraries 610 in the selected set of libraries 610. For example, fraud detector component 550 may select libraries 610 having single transaction rules, multi-transaction rules, merchant-specific rules, industry-specific rules, consumer-specific rules, or the like, based on information in the profile and/or information (if any) in a black or white list. As described above, some rules may be selected for every transaction.

The transaction may be processed using the selected rules (block 1030). For example, fraud detector component 550 may provide the transaction to rule engines 620 corresponding to the selected set of libraries 610 for processing. In one implementation, fraud detector component 550 may provide the transaction for processing by multiple rule engines 620 in parallel. The transaction may also be processed using two or more of the rules, in the selected set of rules of a library 610, in parallel. By processing the transaction using select rules, the accuracy of the results may be improved over processing the transaction using all of the rules (including rules that are irrelevant to the transaction). When a rule triggers (is satisfied), an alarm may be generated. The output of processing the transaction using the selected rules may include zero or more alarms.

The alarms may be collected and sorted (block 1040). For example, fraud detector component 550 may analyze attributes of the transactions with which the alarms are associated (e.g., attributes relating to a particular form of payment, a particular geographic area, a particular consumer, etc.). Fraud detector component 550 may sort the alarms, along with alarms of other transactions (past or present associated with the same or different (unaffiliated) merchants), into cases based on values of the attributes of the transactions associated with alarms. For example, fraud detector component 550 may include one or more alarms associated with a particular credit card number in a first case, one or more alarms associated with a particular travel destination in a second case, one or more alarms associated with a particular country in a third case, etc. As described above, a particular alarm may be included in multiple cases.

The alarms, in one or more cases, may be analyzed across one or more transactions (block 1050). For example, fraud detector component 550 may analyze the alarms in a case (where the alarms may be associated with multiple transactions possibly from multiple, unaffiliated merchants and/or possibly from multiple, different industries) to determine whether the alarms justify a determination that the transaction is potentially fraudulent. By analyzing alarms in multiple cases, fraud detector component 550 may get a good picture of whether fraudulent activity is occurring.

A fraud score may be generated (block 1060). For example, fraud detector component 550 may generate a case score for each of the cases using a technique, such as a technique described previously. Fraud detector component 550 may combine the case scores, associated with the transaction, to generate a fraud score for the transaction. In one implementation, as described above, the case scores, associated with the different cases, may be weighted differently. For example, the fraud score of case 1 may have an associated weight of CW1, the fraud score of case 2 may have an associated weight of CW2, the fraud score of case 3 may have an associated weight of CW3, etc. Thus, in this implementation, the different case scores may not contribute equally to the fraud score. The fraud score may reflect a probability that the transaction is fraudulent.

In one implementation, the fraud score may include a value in the range of 0 to 100, where “0” may reflect a 0% probability that the transaction is fraudulent and “100” may reflect a 100% probability that the transaction is fraudulent. It may be possible for the case score of a particularly important case (with a high weight value) to drive the fraud score to 100 (even without any contribution from any other cases).

An alert may be generated (block 1070). For example, fraud detector component 550 may generate an alert based on the fraud score and policies associated with the merchant. For example, the merchant may specify policies that indicate what fraud scores constitute a safe transaction, what fraud scores constitute an unsafe transaction, and what fraud scores constitute a for review transaction. Fraud detector component 550 may generate an alert that indicates, to the merchant, that the transaction should be permitted or that the transaction should be denied.

Fraud detector component 550 may send the alert and/or the fraud score to the merchant so that the merchant can process the transaction accordingly. In one implementation, fraud detector component 550 may send the alert and/or fraud score while the merchant is still processing the transaction (e.g., before the merchant has approved the transaction). In another implementation, fraud detector component 550 may send the alert and/or fraud score after the merchant has completed processing the transaction (e.g., after the merchant has approved the transaction). In the latter implementation, when the transaction is determined to be potentially fraudulent, the merchant may take measures to minimize its loss (e.g., by canceling the airline tickets, by canceling shipping of the ordered product, by canceling performance of the ordered service, by canceling the payment of a medical claim, etc.).

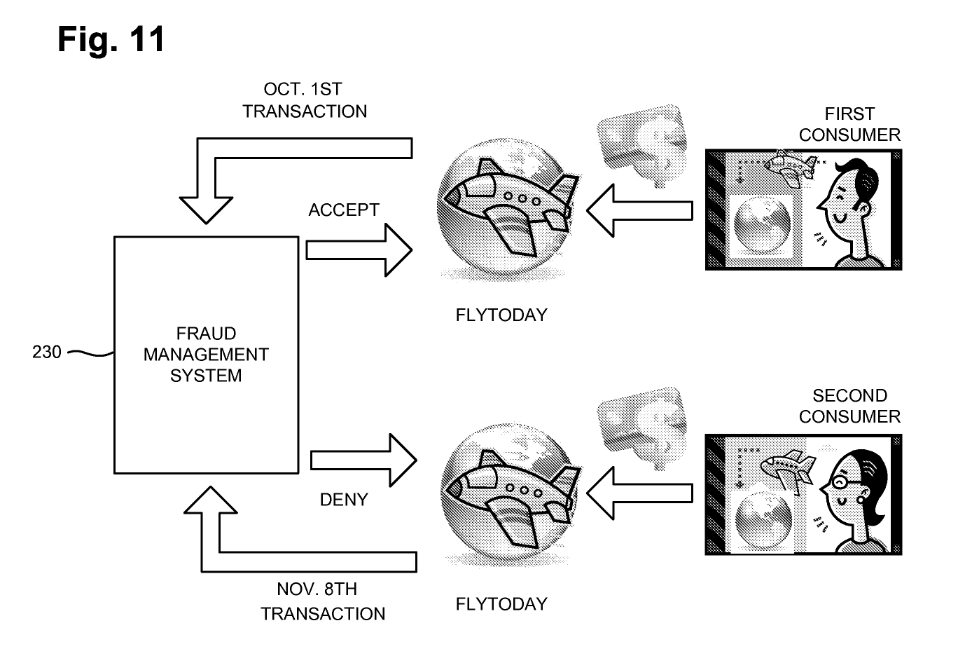

FIG. 11 is a diagram illustrating an example for identifying a fraudulent transaction. As shown in FIG. 11, assume that a first consumer and a second consumer use the same credit card number on the FlyToday website to purchase two trips, which overlap in time, for the same traveler. For example, assume that, on October 1st, the first consumer purchases a trip, for a particular individual, that leaves Phoenix on November 1st for Mexico City and returns to Phoenix on November 10th; and assume that, on November 8th, the second consumer purchases a trip, for that same, particular individual, that leaves Miami on November 8th for Rio de Janeiro and returns to Miami on November 16th. Assume further that charges to this particular credit card number have exceeded $5,000 in the two days preceding the November 8th transaction.

The transactions, associated with these trips, may be processed by fraud management system 230. For example, fraud management system 230 may receive the October 1st transaction, select rules for the transaction, such as travel industry rules, FlyToday-specific rules, credit card rules, Mexico City rules, single transaction rules, multi-transaction rules, etc., and apply the transaction, in parallel, to the selected rules. Assume that a set of the selected rules trigger and generate corresponding alarms. For example, one rule may generate an alarm because the travel is destined for the hot destination of Mexico City (a hot destination may refer to a destination known to be associated with fraudulent activity).

Fraud management system 230 may process the alarms and determine, for example, that the transaction is not fraudulent based on the information known to fraud management system 230 at the time of processing the October 1st transaction. Fraud management system 230 may notify FlyToday that the transaction is not fraudulent. In other words, based on the totality of information available to fraud management system 230 at the time of processing the October 1st transaction, fraud management system 230 may determine that the October 1st transaction is not fraudulent and may notify FlyToday to accept the transaction.

Fraud management system 230 may receive the November 8th transaction, select rules for the transaction, such as travel industry rules, FlyToday-specific rules, credit card rules, Rio de Janeiro rules, Miami rules, single transaction rules, multi-transaction rules, etc., and apply the transaction, in parallel, to the selected rules. Assume that a set of the selected rules trigger and generate corresponding alarms. For example, one rule may generate an alarm because the travel is destined for the hot destination of Rio de Janeiro; another rule may generate an alarm because the travel originated in the hot location of Miami; another rule may generate an alarm because there is overlapping travel (e.g., the travel itineraries overlap—one leaves on November 1st and returns on November 10th, and the other leaves on November 8th and returns on November 16th) for the same traveler; another rule may generate an alarm because the travel on November 8th was booked within five hours of the flight departure (e.g., a possible signal of fraudulent activity); and another rule may generate an alarm due to the excessive charges that have been put on the credit card within the two days proceeding the November 8th transaction.

Fraud management system 230 may process the alarms and determine, for example, that the transaction is potentially fraudulent based on the information known to fraud management system 230 at the time of processing the November 8th transaction. In other words, based on the totality of information available to fraud management system 230 at the time of processing the November 8th transaction, fraud management system 230 may determine that the November 8th transaction is potentially fraudulent and may notify FlyToday to deny, or not fulfill, the transaction. Fraud management system 230 may also notify FlyToday that the October 1st transaction may have also been fraudulent.

An implementation, described herein, may determine potentially fraudulent transactions by processing transactions, in parallel, using select rules. For example, each transaction may be processed, in parallel, by rules that have been selected for the transaction and alarms may be generated when the rules are triggered. The alarms may be processed in making a fraud determination. By processing the transactions with only select rules, the accuracy of the fraud determination may be improved by, for example, reducing the incidents of false positives.

The foregoing description provides illustration and description, but is not intended to be exhaustive or to limit the invention to the precise form disclosed. Modifications and variations are possible in light of the above disclosure or may be acquired from practice of the invention.

For example, while a series of blocks has been described with regard to FIG. 10, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
storing, by one or more computer devices of a fraud management system, a plurality of rules for detecting fraud;
receiving, by the one or more computer devices, a transaction involving a consumer and a merchant;
selecting, by the one or more computer devices, rules, from the plurality of rules, based on information associated with the transaction, information associated with the consumer, or information associated with the merchant;
processing, by the one or more computer devices, the transaction, in parallel, using the selected rules to generate a plurality of alarms;
sorting, by the one or more computer devices, the plurality of alarms into a plurality of cases based on attributes of the transaction, where one or more of the plurality of cases include alarms from a plurality of transactions;
analyzing, by the one or more computer devices, the plurality of cases to generate a fraud score; and
outputting, by the one or more computer devices, information regarding the fraud score to the merchant to assist the merchant in determining whether to accept, deny, or fulfill the transaction.

2. The method of claim 1, further comprising:
generating the plurality of rules using a heuristic-based technique or a pattern recognition technique.

3. The method of claim 1, further comprising:
generating a profile associated with the transaction based on information included in the transaction, meta information associated with the transaction, third party information associated with the transaction, or historical information associated with the transaction; and
where selecting the rules includes selecting the rules based on information in the profile.

4. The method of claim 1, where processing the transaction includes:
processing, in parallel, the transaction by a first rule, of the selected rules, and a second rule, of the selected rules, where processing of the transaction by the first rule generates one of the plurality of alarms, and processing of the transaction by the second rule generates no alarm.

5. The method of claim 1, where analyzing the plurality of cases includes:
generating initial fraud scores for the plurality of cases, and
combining the initial fraud scores to generate the fraud score.

6. The method of claim 5, where generating the initial fraud scores includes:
assigning a first weight to the initial fraud score for one of the plurality of cases, and
assigning a second weight to the initial fraud score for another one of the plurality of cases, where the first weight differs from the second weight.

7. The method of claim 1, where outputting information regarding the fraud score includes:
determining policies associated with the merchant,
generating an alert, associated with the transaction, based on the fraud score and the determined policies, where the alert indicates that the merchant should accept, deny, or fulfill the transaction, and
outputting the alert to the merchant.

8. The method of claim 1, further comprising:
flagging the transaction for review by a human analyzer based on the fraud score.

9. The method of claim 1, further comprising:
analyzing the fraud score with respect to first and second thresholds, where the first threshold is less than the second threshold;
classifying the transaction as a safe transaction when the fraud score is less than the first threshold; and
classifying the transaction as an unsafe transaction when the fraud score is greater than the second threshold.

10. A system, comprising:
one or more memory devices to store a plurality of rules for detecting fraud; and
one or more processors to:
receive a transaction involving a consumer and a merchant;
select rules, from the plurality of rules, based on information associated with the transaction, information associated with the consumer, or information associated with the merchant;
process the transaction, in parallel, using the selected rules to generate a plurality of alarms;
combine the plurality of alarms with alarms from one or more other transactions to form a combined set of alarms;
sort alarms, in the combined set of alarms, into groups based on attributes of the transaction;
analyze the groups of alarms to generate a fraud score for the transaction; and
output information regarding the fraud score to the merchant to notify the merchant whether the transaction is potentially fraudulent.

11. The system of claim 10, where the plurality of rules include at least two of: general rules applicable to all transactions; merchant-specific rules applicable to transactions associated with the merchant; industry-specific rules applicable to transactions associated with an industry with which the merchant is associated; consumer-specific rules applicable to transactions associated with the consumer; single transaction rules associated with a single transaction; multi-transaction rules associated with multiple transactions; heuristic rules; pattern recognition rules; or transaction attribute rules applicable to an attribute of the transaction.

12. The system of claim 10, where the one or more other transactions originate from at least one merchant that is unaffiliated with the merchant.

13. The system of claim 10, where two or more of the groups includes a same one of the alarms.

14. The system of claim 10, further comprising:
at least one processor to generate the plurality of rules using a heuristic-based technique or a pattern recognition technique.

15. The system of claim 10, where, when processing the transaction, the one or more processors are to process, in parallel, the transaction by a first rule, of the selected rules, and a second rule, of the selected rules, where processing of the transaction by the first rule generates one of the plurality of alarms, and processing of the transaction by the second rule generates no alarm.

16. The system of claim 10, where, when analyzing the groups of alarms, the one or more processors are to:
generate initial fraud scores for the groups of alarms, and
combine the initial fraud scores to generate the fraud score for the transaction.

17. The system of claim 10, where, when outputting information regarding the fraud score, the one or more processors are to:
determine policies associated with the merchant,
generate an alert, associated with the transaction, based on the fraud score and the determined policies, where the alert indicates that the merchant should accept, deny, or fulfill the transaction, and
output the alert to the merchant.

18. A non-transitory computer-readable medium that stores instructions executable by one or more computer devices to perform a method, the method comprising:
storing a plurality of rules for detecting fraud;
receiving a transaction involving a consumer and a merchant;
selecting rules, from the plurality of rules, based on information associated with the transaction, information associated with the consumer, or information associated with the merchant;
processing the transaction, in parallel, using the selected rules to generate a plurality of alarms;
grouping the alarms, into groups, based on information associated with the transaction, where one of the alarms is included in a plurality of the groups and where at least one of the groups includes alarms associated with a plurality of transactions;
analyzing the groups to generate a fraud score; and
outputting information regarding the fraud score to the merchant to notify the merchant whether the transaction is potentially fraudulent.

19. The computer-readable medium of claim 18, where the method further comprises:
analyzing the fraud score with respect to first and second thresholds, where the first threshold is less than the second threshold;
classifying the transaction as a safe transaction when the fraud score is less than the first threshold; and
classifying the transaction as an unsafe transaction when the fraud score is greater than the second threshold;
where outputting information regarding the fraud score includes outputting information identifying the transaction as a safe transaction or an unsafe transaction.

20. The computer-readable medium of claim 18, where the method further comprises:
generating a profile associated with the transaction based on information included in the transaction, meta information associated with the transaction, third party information associated with the transaction, or historical information associated with the transaction; and
where selecting the rules includes selecting the rules based on information in the profile.
